(19) United States
(12) Patent Application Publication
(10) Pub. No.: US 2006/0279413 A1
(43) Pub. Date: Dec. 14, 2006

(54) Radio frequency identification device

(75) Inventor: C. Douglas Yeager, Knoxville, TN (US)

Correspondence Address: HAYNES AND BOONE, LLP, 901 MAIN STREET, SUITE 3100, DALLAS, TX, 75202, US

(73) Assignee: Sirit Technologies, Inc., Toronto (CA)

(21) Appl. No.: 11/384,708

(22) Filed: Mar. 20, 2006

Related U.S. Application Data
(63) Continuation of application No. 60/665,772, filed on Mar. 28, 2005.

(51) Int. Cl. H04Q 5/22

(52) U.S. Cl. 340/10.51; 235/380; 340/572.1; 340/10.1

(57) ABSTRACT

An RFID device comprises an RFID module operable to communicate with an RFID tag, and an interface circuitry coupled to the RFID module operable to enable data communications between the RFID module and a mobile device.

### RELATED APPLICATION

This application claims the benefit of U.S. Provisional Patent Application No. 60/665,772 filed Mar. 28, 2005, entitled Secure Digital Input/Output Radio Frequency Identification Tag Reader/Writer.

### BACKGROUND

Radio Frequency Identification (RFID) tags and labels are typically passive devices that have the ability to store information that can be retrieved when a RFID reader comes into close proximity with the tag or label. Specialized electronic devices have been developed to write and read information to and from RFID tags. However, the cost of acquiring such specialized electronic devices limits the market acceptance and useful applications of the RFID technology.

### BRIEF DESCRIPTION OF THE DRAWINGS

Aspects of the present disclosure are best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIGS. 1a-1c are various views of an embodiment of a radio frequency identification (RFID) reader/writer adapted to be easily coupled to a general purpose computing device;

FIG. 2 is a perspective view of an embodiment of an RFID reader/writer coupled to a general purpose computing device such as a personal digital assistant (PDA);

FIG. 3 is a simplified diagram of a secured digital (SD) interface pin placement and assignment;

FIG. 4 is a simplified block diagram of an embodiment of an SDIO module of the RFID reader/writer;

FIG. 5 is a simplified data flow diagram of an embodiment of RFID reader/writer; and

FIG. 6 is a more detailed data flow diagram of an embodiment of RFID reader/writer.

### DETAILED DESCRIPTION

RFID or radio frequency identification technology has been used in a variety of commercial applications such as inventory tracking and highway toll tags. In general, a transceiver tag or transponder transmits stored data by backscattering varying amounts of an electromagnetic field generated by an RFID reader. The RFID tag may be a passive device that derives its electrical energy from the received electromagnetic field or may be an active device that incorporates its own power source. The backscattered energy is then read by the RFID reader and the data is extracted therefrom. RFID readers are operable to read the stored data in an RFID tag, and some RFID readers are further operable to write data to the tags.

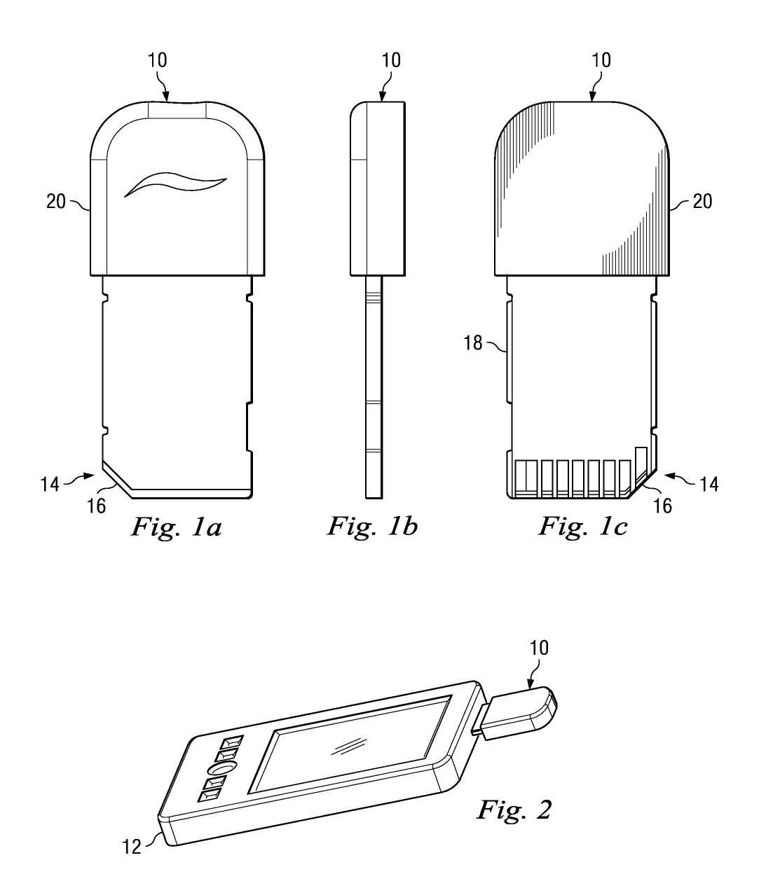

FIGS. 1a-1c are three views of an embodiment of an RFID reader 10 that is operable to interface with a general purpose computing device 12, shown in FIG. 2, such as a mobile telephone, a portable computer, or a personal digital assistant (PDA). Many of these general purpose devices have a built-in interface card slot or connector and are hereinafter referred to as host devices.

One example of a standard governing the protocol for communicating across the interface card slot is the Secure Digital (SD) standard. The SD standard was first developed as a flash memory card format. It is commonly used in memory devices for portable devices, including digital cameras and handheld computers. The SD interface or SDIO (Secure Digital imput/output) has become an interface that can be used with devices other than flash memory cards. RFID reader 10 may comprise an SDIO interface 14 that communicates with a host device 12 with a SD card slot. SDIO interface 14 has a standard 9-pin configuration, and a chamfered corner 16 and a guide rail 18 to facilitate proper orientation and insertion into the SDIO card slot. RFID reader 10 has an integrated SD card interface so that it fits physically into an SD slot that is common on many PDAs or portable computers. Preferably, RFID reader 10 has a very small footprint so that it does not protrude significantly beyond the profiles of the mobile host device. RFID reader 10 may have dimensions that do not exceed 40mm×80mm×20mm, for example.

RFID reader 10 further comprises an outer case 20 that houses an RF antenna and RFID read and write circuit (also hereinafter referred to as an RFID module). Outer case 20 preferably has a first portion and a second portion that fit together to accommodate the electronics in a protected environment. When inserted into the card slot interface on a PDA, the RFID antenna housed within outer case 20 preferably extends beyond the card slot outside of the PDA so that its reception/transmission capability is not impeded.

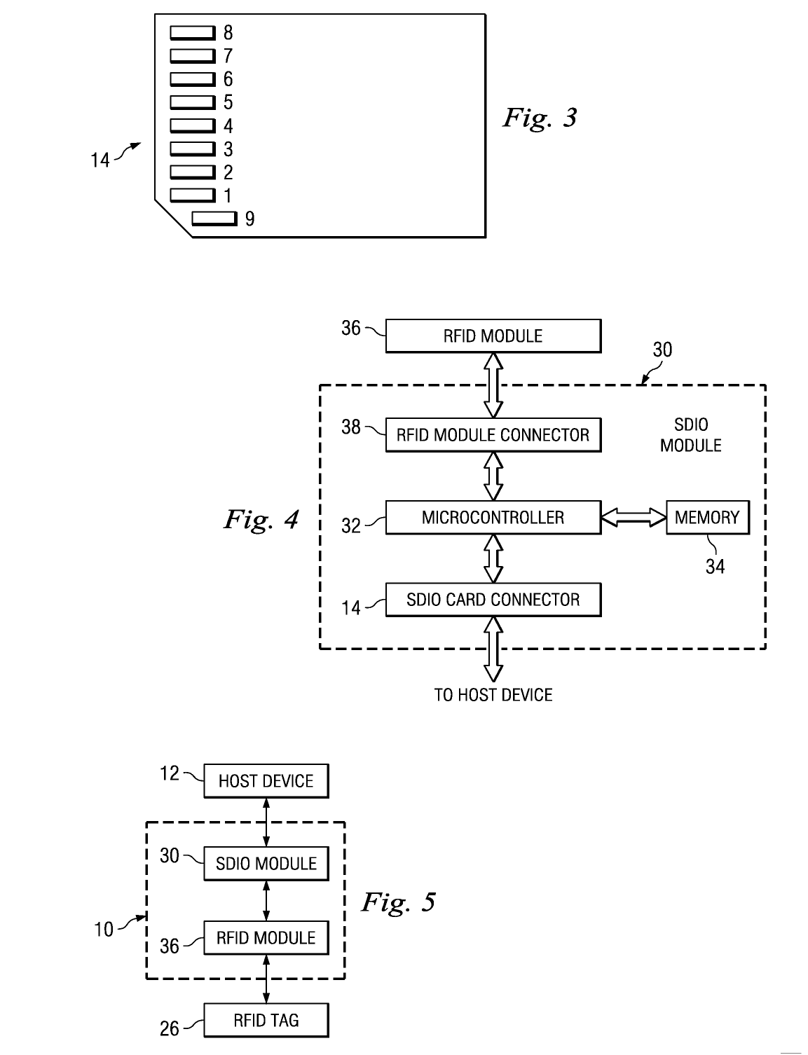

FIG. 3 is a diagram that provides the pin numbering convention of SDIO interface 14 scribed in the table below:

| Pin | SD 4-Bit Mode | | SD 1-Bit Mode | | SPI Mode | |
|---|---|---|---|---|---|---|
| 1 | CD/D3 | Card Detect/Data [3] | NC | Not Used | CS | Card Select/Data |
| 2 | CMD | Command | CMD | Command | DI | Data Input |
| 3 | VSS1 | Ground | VSS1 | Ground | VSS1 | Ground |
| 4 | VDD | Supply Voltage | VDD | Supply | VDD | Supply Voltage |
| 5 | CLK | Clock | CLK | Clock | SCLK | Clock |
| 6 | VSS2 | Ground | VSS2 | Ground | VSS2 | Ground |
| 7 | D0 | Data [0] | DATA | Data Line | DO | Data Output |
| 8 | D1 | Data [1] | IRQ | Interrupt | IRQ | Interrupt |
| 9 | D2 | Data [2] or Read Wait | RW | Read Wait | NC | Not Used |

SDIO interface 14 enables connection and communication with host device 12. SDIO interface 14 generally achieves electrical connection with an SD bus internal to the host device. The SD bus may transfer data between the host device and RFID reader 10 using either a 1-bit data bus (pin 2) or 4-bit data bus (pin 2 and pins 7-9). The SDIO interface provides a clock signal on pin 5 from host device 12 to RFID reader 10. In addition, SDIO interface 14 has a bidirectional command/response signal line on pin 2. The data transfer is done synchronously and the data bus width can be changed dynamically by the host device. RFID reader 10 may operate at a low speed (where the SD clock is 0-400 KHz) or at a high speed (0-50 MHz). Peripheral devices containing both memory and I/O preferably are set up as full speed devices. The SD bus may provide a maximum data transfer rate of 200 Megabits/sec. In a preferred embodiment of RFID reader 10, SDIO interface 14 transfers data between the host device and the RFID reader using a 1-bit data bus in serial peripheral interface (SPI) mode. Additional details of the SDIO interface may be obtained by consulting Secure Digital Input/Output (SDIO) Card Specification, Version 1.00, October 2001, by the SD Association.

FIG. 4 is a simplified block diagram of an SDIO module 30 residing within RFID reader 10. SDIO module 30 includes a microcontroller 32 coupled to a memory 34. Memory 34 may be implemented by one or more registers, for example. Microcontroller 32 is further coupled to host device 12 via SDIO connector 14, and to an RFID module 36 via an RFID module connector 38. RFID module 36 may comprise components found in typical RFID readers, including antenna, RF receiver, RF transmitter, carrier signal generator, demodulator, microprocessor, etc. SDIO module 30 may have from one to seven I/O functions plus one memory function. Memory 34 includes a common I/O area (CIA) that is accessible by the host device via I/O reads and writes to function 0. The registers within the CIA are provided to enable/disable the operation of the I/O functions, control the generation of interrupts, and optionally load software to support the I/O functions. CIA includes card common control registers (CCCR) that allows the host device to quickly check and control the SDIO's enable and interrupts on a per card and per function basis. CIA also includes function basic registers (FBRs) that support each I/O function. CIA further includes a card information structure (CIS) that provides more complete information about the SDIO card and the individual functions, and provides information about all I/O functions supported by the SDIO card. In addition to CIA, memory 34 may also include a code storage area (CSA) that provide storage of drivers and other application to support “plug-and-play” of the SDIO card.

FIG. 5 is a data flow diagram of the communication between the various components during the process of reading or writing to an RFID tag or label. Host device 12 issues appropriate command tokens to SDIO module 30. Command tokens issued from host device 12 may contain specific addresses to access the register or memory locations inside SDIO module 30. Data can be either the part of command/response tokens or they can flow in separate data blocks between host device 12 and SDIO module 30. Application-specific commands may be used to implement the security features in SDIO module 30. SDIO module 30 may have up to seven I/O functions along with the memory and function number present in the commands helps the host device to access the different functions. Typical data transfer between the host device and SDIO module 30 takes place on interruption to host device 12. SDIO module 30 may signal interrupt using a data signal line and the host device will issue the data transfer command to SDIO module 30. The SDIO protocol provides ways to control the data transfer rate between host device 12 and SDIO module 30. SDIO module 30 may indicate a “Busy” condition via a data line during a write operation from the host device. The host device may ask the SDIO module 30 to “wait” by signaling through a data line during the read operation from the SDIO module 30.

In operation, host device 12 may execute an RFID application that in turn issues an instruction to RFID module 36, via SDIO module 30, to scan for nearby RFID tags. Upon detecting an RFID tag 26, its stored contents are read by RFID module 36, and then conveyed to host device 12, again via SDIO module 30. Host device 12 may then optionally instruct RFID module 36, via SDIO module 30, to write specific data to the memory of RFID tag 26.

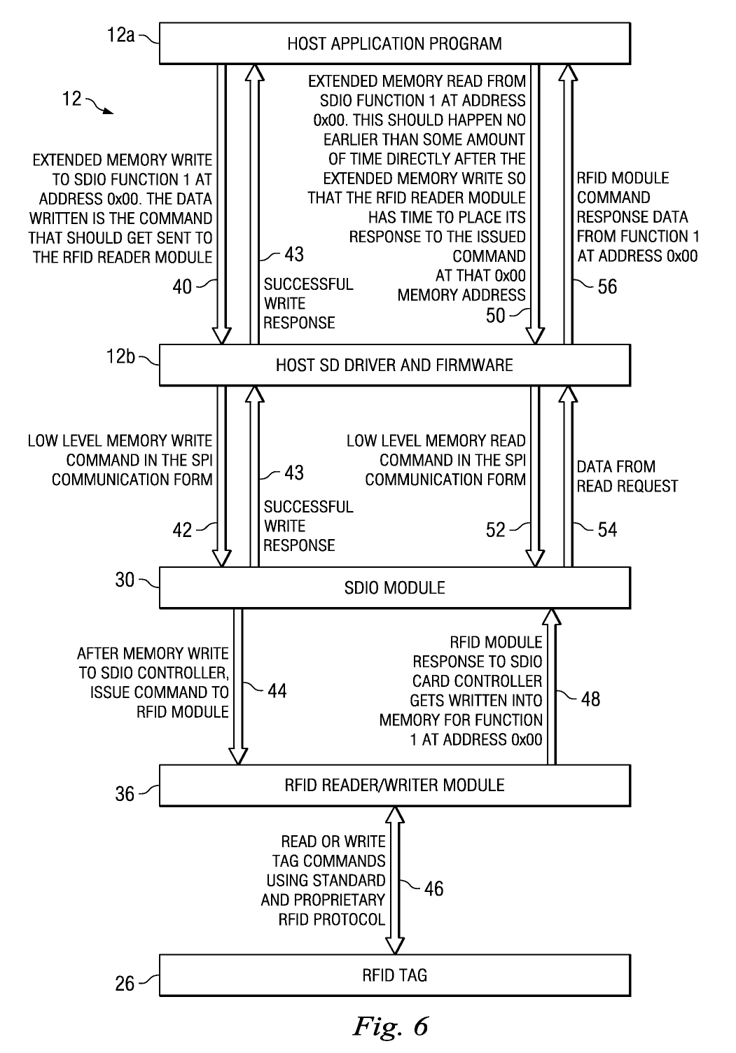

FIG. 6 is a more detailed data flow diagram illustrating an embodiment of the software and hardware read/write communication process. Host device 12 comprises a host application program 12a and a host SD driver and associated firmware 12b. Host application program 12a issues an extended memory write 40 to host SD driver and firmware 12b. The data written is the command written to a particular memory address representing a specific SDIO function. Host SD driver and firmware 12b in turn issues a low-level memory write command 42 to SDIO module 30. A successful write response feedback 43 is provided from SDIO module 30 to host SD driver and firmware 12b, and also to host application program 12a. The communication between SSDIO module and host device 12 may be performed in the SPI communication mode of the SDIO interface. SDIO module 30 then issues the command 44 to RFID module 36. The RFID module then performs a read tag command 46 and receives backscattered data from RFID tag 26. RFID module 36 sends a response 48 to SDIO module 30 which is written to a SDIO memory location. Host application program 12a then issues an extende memory read command 50 to host SD driver and firmware 12b. Host SD driver and firmware 12b issues a low-level memory read command 52 in the SPI mode to SDIO module 30 to read the data that was stored in SDIO memory. SDIO module 30 then provides the data 54 from the memory storage location to host SD driver and firmware 12b, which then passes it onto host application program as an RFID module command response data 56.

By providing the RFID device described above, a general purpose computing device can function as an RFID reader/writer that is operable to read data stored in an RFID tag and also write data to the memory of the RFID tag. By using an interface such as the SDIO interface, the RFID device can be easily inserted into an SD card slot of a PDA, for example, and become operable as an RFID reader/writer. Accordingly, the expense of providing dedicated and specialized RFID readers/writers can be avoided. This broadening of the RFID platform will further enable RFID technology to become the ubiquitous technology for inventory tracking, cashless transactions, and other applications.

Although the descriptions above place an emphasis on SDIO technology, other suitable interface and I/O technologies now known or to be developed may also be used. For example, MiniSD, PCMCIA (Personal Computer Memory Card International Association), CF (compact flash), USB (universal serial bus) and other I/O interfaces may also be used.

Although embodiments of the present disclosure have been described in detail, those skilled in the art should understand that they may make various changes, substitutions and alterations herein without departing from the spirit and scope of the present disclosure. Accordingly, all such changes, substitutions and alterations are intended to be included within the scope of the present disclosure as defined in the following claims. In the claims, means-plus-function clauses are intended to cover the structures described herein as performing the recited function and not only structural equivalents, but also equivalent structures.

What is claimed is:

1. An RFID device comprising:
an RFID module operable to communicate with an RFID tag; and
an interface circuitry coupled to the RFID module operable to enable data communications between the RFID module and a mobile device.

2. The RFID device of claim 1, wherein the RFID module is operable to read data stored in the RFID tag.

3. The RFID device of claim 1, wherein the RFID module is operable to write data for storage in the RFID tag.

4. The RFID device of claim 1, wherein the interface circuitry comprises an SDIO interface.

5. The RFID device of claim 1, wherein the interface circuitry comprises an SDIO interface operable to be inserted into an SD card slot of the mobile device.

6. The RFID device of claim 1, wherein the interface circuitry comprises an SDIO module having an SD interface having a plurality of pins.

7. The RFID device of claim 1, wherein the interface circuitry comprises a chamfered corner.

8. The RFID device of claim 1, wherein the interface circuitry comprises a guide rail.

9. The RFID device of claim 1, wherein the interface circuitry comprises at least one of SD, MiniSD, USB, PCMCIA, and CF interface.

10. An RFID device comprising:
an RFID module operable to write and read data to and from an RFID tag; and
an SDIO module coupled to the RFID module and operable to enable data communications between the RFID module and a general purpose computing device, the SDIO module having a card configuration with a plurality of pins operable to be inserted into a card slot of the general purpose computing device.

11. The RFID device of claim 10, wherein the RFID module is operable to read data stored in the RFID tag.

12. The RFID device of claim 10, wherein the RFID module is operable to write data for storage in the RFID tag.

13. The RFID device of claim 10, wherein the SDIO module is operable to be inserted into an SD card slot of the general purpose computing device.

14. The RFID device of claim 10, further comprising:
an outer case covering the RFID module and the SDIO module, the RFID module being disposed in a distal end of the outer case and the SDIO module being disposed in a proximal end of the outer case;
a plurality of pins disposed along an edge of the proximal end of the outer case;
a chamfered corner defined in the proximal end of the outer case; and
a guard rail defined along one edge of the outer case to facilitate proper orientation and insertion of the RFID device into the card slot.

15. A method of communicating with an RFID tag comprising:
generating a read command in a general purpose computing device;
transmitting the read command to an RFID module via an interface circuitry coupled between the general purpose computing device and the RFID module;
reading data stored in the RFID tag by the RFID module; and
communicating the data to the general purpose computing device via the interface circuitry.

16. The method of claim 15, wherein transmitting the read command to an RFID module via an interface circuitry comprises transmitting the read command to the RFID module via an SDIO module.

17. The method of claim 15, wherein transmitting the read command to an RFID module via an interface circuitry comprises transmitting the read command to the RFID module via an SDIO module operating in SPI mode.

18. The method of claim 15, further comprising:
generating a write command in the general purpose computing device;
transmitting the write command to an RFID module via an interface circuitry coupled between the general purpose computing device and the RFID module; and
writing data to the RFID tag by the RFID module.

19. The method of claim 18, wherein transmitting the write command to an RFID module via an interface circuitry comprises transmitting the write command to the RFID module via an SDIO module.

20. The method of claim 18, wherein transmitting the write command to an RFID module via an interface circuitry comprises transmitting the write command to the RFID module via an SDIO module operating in SPI mode.
